(19) United States
(12) Patent Application Publication
(10) Pub. No.: US 2007/0288248 A1
(43) Pub. Date: Dec. 13, 2007

(54) System and method for online service of web wide datasets forming, joining and mining

(76) Inventor: Rami Rauch, Palo Alto, CA (US)

Correspondence Address: SUGHRUE MION, PLLC, 401 Castro Street, Ste 220, Mountain View, CA, 94041-2007, US

(21) Appl. No.: 11/515,339

(22) Filed: Aug. 31, 2006

Related U.S. Application Data
(60) Provisional application No. 60/812,861, filed on Jun. 12, 2006.

(51) Int. Cl. G06Q 10/00; G06Q 30/00

(52) U.S. Cl. 705/1

(57) ABSTRACT

Data mining from remote and disparate data providers is enabled without the need for local arranging and processing. Users have a single “point of entry” to data providers that allows query submission, data collection and assembly, and performing various operations on the datasets obtained from the various data providers (e.g. web databases). The operations on the dataset do not require any change in the format or semantics used by the various data providers. The user is also able to structure a mining strategy without having to visit any of the database provider's websites and without having to download any data from these websites.

### CROSS-REFERENCE TO RELATED APPLICATION

This Application claims priority from U.S. Provisional Patent Application Ser. No. 60/812,861, filed Jun. 12, 2006, the entire content of which is incorporated herein by reference.

### BACKGROUND

1. Field of the Invention

The subject invention relates to data mining from various data providers, especially for data providers that make their data available for access via the World Wide Web (the “Web”).

2. Related Art

It is well known in the art to provide access to databases via the Web. Various mechanisms are provided in the art to search such databases to obtain relevant data. For example, search engines, such as Google™, Yahoo™, MSN™, etc., enable users to search databases for information relating to query terms.

Also, various websites provide search capability within the website, so as to enable searching of the database of the website owner. One such service that is familiar to patent practitioners is the U.S. Patent and Trademark Office (“USPTO”) website, which enable one to search the database of issued patents and published patent applications. Thus, for example, one may be able to obtain all of the patents that were issued to company XYZ between 1990-2000, etc.

Moreover, some websites allow a “dump” of their database upon a request by a user. That is, upon a request by a user, the entire content of the database would be downloaded to the user's machine. Such a download may be available for a fee or free of charge, and would maintain the original database fields attributes. For example, a download from the USPTO may include fields such as “Title,” “Inventor,” “Assignee,” etc.

Because of the vast amount of information available from databases that are connected to the Web, a huge synergistic effect can be gained if one was able to cross information from different databases. For example, one may want to cross data from the USPTO of the number of patents company XYZ was granted in each year from 1990-2000, with data from a business website (e.g., securities and Exchange Commission) showing how much money the company invested in R&D each year between 1990-2000. This will enable one to, e.g., calculate a ratio of number of patents per R&D dollars spent per year. However, heretofore to perform such an operation, one would have to first download the data from one website, then download the data from a second website, and then reformat the data to make sure that the fields of both datasets correspond to each other. For example, the USPTO data would include at least two fields of dates: “filing date” and “issued date.” There can even be more date fields, e.g., “priority date,” “publication date,” etc. On the other hand, the data from the second site may not call the field a date, but rather use a different term, e.g., “period,” “FY,” (for fiscal year) “CY,” (for calendar year), etc. Moreover, the other site may not use years, but rather quarters. Therefore, the data from both sites needs to be modified to be able to perform the requested process. Of course, such processing is rapidly magnified if one tried to cross more than two datasets.

FIGS. 1a and 1b depict the prior art Web data mining environment. In FIG. 1a, a user 120 accesses the Internet 140 using a PC 130. The user wishes to cross data from two databases of data provider 110 and data provider 115. To do that, the user 120 first sends a query 122 to data provider 110, and received results 124. Then the user 120 sends a different query 126 to data provider 115 and receives results 128. The user must save the results 124 and 128 on the local machine, e.g., PC 130, for local processing. Once saved, the user needs to arrange the two results 124 and 128 so that their fields correspond to each other. For example, Data provider 110 may have a field called “car,” while data provider 115 may call a corresponding field “automobile.” The user must arrange these datasets to conform to one chosen convention. The user may then join the two data sets and mine the information sought after to obtain the mining results 150.

FIG. 1b depicts three data providers, websites D, U and T, providing access to their databases via the Internet 140. As depicted by the solid double-head arrows, each client, 10, 12, or 14, is able to directly access any of the data providers via the Internet 140 and submit a query to search the databases of the data providers. However, as shown by the broken lines 11, 13, and 15, a synergistic effect can be gained if one was able to cross datasets from the various data providers. However, this is not enabled in the prior art. Accordingly, there is a need in the art for an improved ability to mine web databases.

Incidentally, as can be understood, while the discussion and the examples provided herein are sometimes in terms of the Web and Internet, it is equally applicable to other networks, such as a company's intranet, etc. For example, the situation described in FIG. 1b holds true for any network, such as Internet or intranet. For the intranet case, if the intranet is maintained by a particular company, for example, then Data Provider D may be the human resources database, Data Provider U may be the accounting department database, etc. The clients 10, 12, or 14, may be users that are internal to the company, such as employees, or they may be users outside the company having limited access to various databases, such as users of the general population or users having increased access, such as contractors.

### SUMMARY

The subject invention provides a method and apparatus to enable crossing information from multiple data providers for enhanced data mining. A benefit of the invention is that it enables forming, relating and joining datasets between remote and disparate data providers. As noted above, the terms remote and disparate is rather relative and depends on the particular scenario. For example, a company may have two different databases maintained on two servers that reside in the same room, or even maintained on a single server. However, since the two databases are distinct or autonomous, and crossing datasets between the two requires separate access to each, they may be considered to be remote and disparate.

According to an aspect of the invention, the inventive method makes use of and enhances data provider's expertise in building and organizing search engines and datasets. Much of this expertise is manifested in the way the data provider structures and operates its query engine to provide a results relating to an input query. Therefore, according to an aspect of the invention the method enables connecting between ‘query outputs’ rather then the data provider's database. According to various embodiments of the invention, this is done by integrating between query interfaces so as to produce relevant datasets, and operating on these datasets. According to various embodiments of the invention, the operation is performed on the fields that relates to the generated datasets, rather than the original database fields.

According to an aspect of the invention, a method for enabling data mining from data providers comprises maintaining a knowledgebase, the knowledgebase storing information of a plurality of data providers and an ordered list of data fields for each respective data provider; for each respective data provider, providing a template for a customized result page, the template reflecting the data fields of the ordered list of the data fields; providing an interface enabling a user to perform a selection of target data providers of the plurality of data providers and target fields from the ordered list of the data fields corresponding to the target data providers, and further enabling the user to indicate a selected operation to be performed on datasets to be generated by the selection; retrieving data produced by the target data providers according to the target fields indicated by the selection so as to generate the datasets; and performing the selected operation on the datasets. According to a specific aspect, the method includes providing a registration interface for enabling registration of data providers. According to a further aspect, the registration of data providers comprises submitting data field names corresponding to data fields used in a data provider to be registered. According to yet another aspect, the registration further comprises submitting record names corresponding to records stored in the data provider to be registered. The registration of data providers may comprise submitting a query network address and a results network address for a data provider to be registered. The method may further include storing a query network address and a results network address for each data provider of the plurality of data providers. The template may comprise value fields corresponding to data fields of the respective data provider output. The value fields may comprise record identification fields and record description fields. The value fields may comprise variable names corresponding to variable data entries. The value fields may be ordered according to the ordered list of the data fields of the respective data provider output. The retrieving part may comprise submitting queries to the target data providers and fetching the customized result page from each of the target data providers. The performing the selected operation part may comprise joining the datasets.

According to other aspects of the invention, a computerized system enabling data mining from data providers accessible by a network comprises: a memory storing therein information of a plurality of data providers and an ordered list of data fields for each respective data provider; a processor receiving first result data from a data provider of the selected data providers and storing the first result data as a first dataset organized according to the ordered list of data fields, the processor further receiving a second result data from a data provider of the selected data providers and storing the second result data as a second dataset organized according to the ordered list of data fields; an interface enabling a user to indicate a selected operation to be performed on the first and second datasets; and, a data mining module operable to perform the selected operation on the first and second datasets. The interface may further enable the user to perform a selection of target data providers of the plurality of data providers and target fields from the ordered list of the data fields corresponding to the target data providers. The processor may further function to compose a query upon the user's selection of a target data provider and send the query to the target data provider. The system may further comprises a registration module functioning to receive field names from a registrant data provider and storing the field names in the memory. The registration module may further function to provide a template to the registrant data provider. The registration module may further function to assign a category to the registrant data provider and to store the category in the memory. The registration module may further function to assign a record name to records of the registrant data provider and to store the record name in the memory. The registration module may further function to modify the registrant data provider by adding a customized results page to the registrant data provider. The memory may store query page address and result page address for each of the plurality of data providers. The system may further comprise a query module for fetching a query page of a data provider and presenting a corresponding query page on the interface. The aid query interface may further insert a modified result page address in the corresponding query interface.

According to yet other aspects of the invention, a method is provided for automatically generating a parser module for a query results page returned from a data provider, the method comprising: displaying on a monitor the result page; receiving a user input identifying fields of interest in the results page; fetching from source code of the results page unique codes corresponding to each on of the fields; and generating a parser operable to receive a results page from the data provider and fetch data corresponding to the unique codes.

### BRIEF DESCRIPTION OF THE DRAWINGS

FIGS. 1a and 1b depict the prior art Web data mining environment.

FIGS. 2a and 2b are conceptual illustrations of data mining according to embodiments of the invention.

FIG. 3 illustrates the registration interaction between a data provider and a DataYours server according to an embodiment of the invention.

FIG. 4 depicts an example of the main elements of a DataYours server 460 according to an embodiment of the invention.

FIG. 5 is a conceptual diagram illustrating a process flow for data mining according to an embodiment of the invention.

FIG. 6 depicts query interface comparison between the prior art method and according to an embodiment of the invention.

FIG. 7 depicts a method for fetching data results according to an embodiment of the invention.

FIG. 8 depicts data mining according to an embodiment of the invention.

FIGS. 9a and 9b depicts two ways in which a user can use DataYours interface according to embodiments of the invention.

FIGS. 10-16 are screen shots illustrating an example of registration process according to an embodiment of the invention.

FIG. 17 depicts an example of data mining process according to an embodiment of the invention, while FIGS. 18 and 19 illustrate screenshots of two points in this process.

FIG. 20 depicts an embodiment of Web categorization according to an embodiment of the invention.

FIGS. 21a and 21b depict and embodiment of the invention referred to herein as “express registration.”

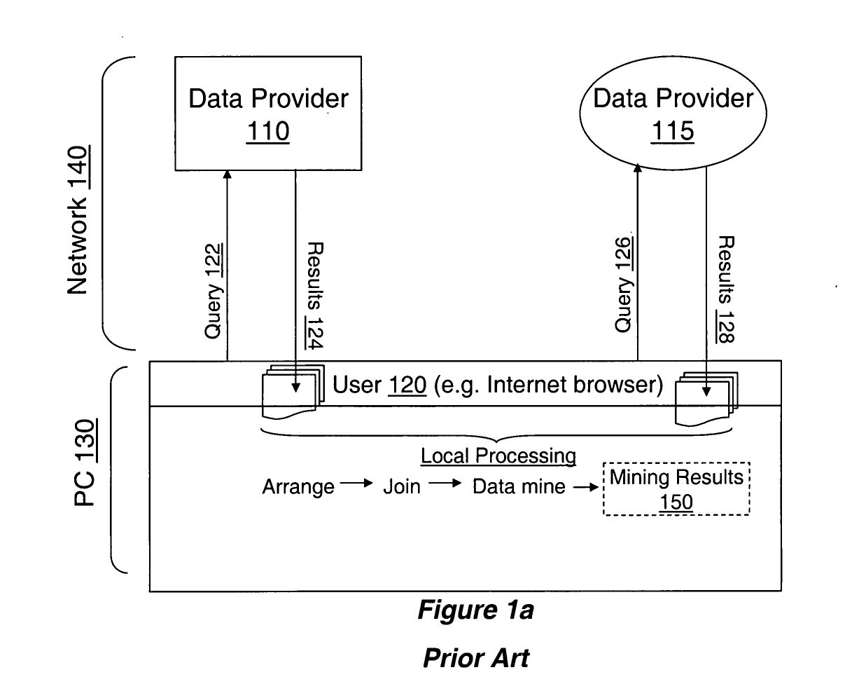

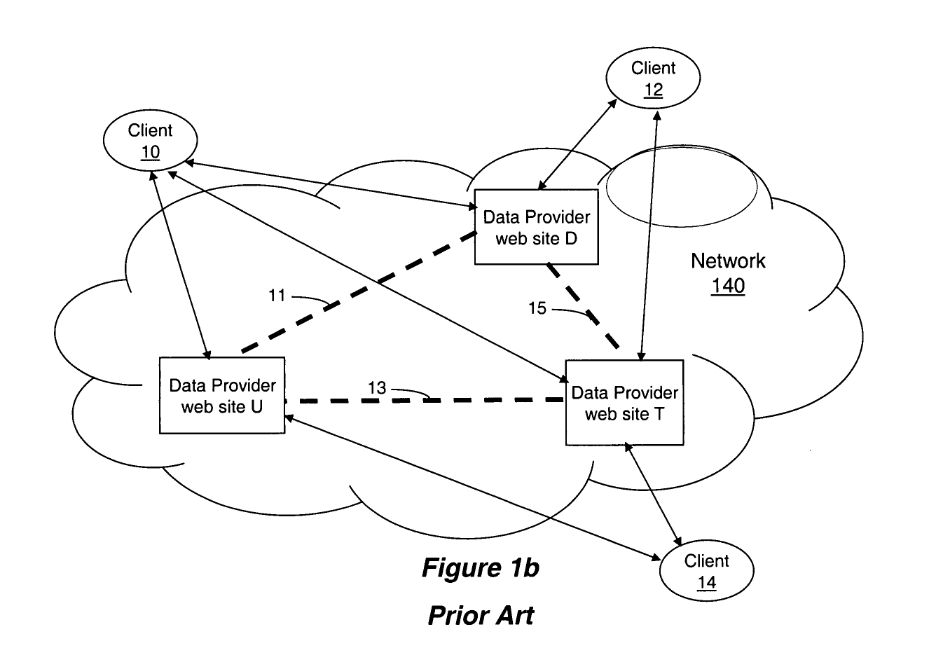

### DETAILED DESCRIPTION

Various embodiments of the invention enable data mining from remote and disparate data providers without the need for local arranging and processing. The embodiments also provided a single “point of entry” to data providers and allow for query submission and data collection and assembly via a single interface. The single interface also allows the user to perform various operations on the datasets obtained from the various databases. In this respect, references herein to data providers encompass entities that provide a service capable of publishing structured information accessible via a network. Such entities may maintain the data in various formats, such as traditional databases, flat files, or otherwise. The various embodiments of the invention as described herein can work with any such data provider, regardless of the manner in which the data is maintained by the data provider. Therefore, to simplify, in various descriptions herein the term database may be used, which is meant to encompass any manner of storing structured data.

An aspect of the subject invention is that it does not interfere with the structure and organization of any database provider. To the contrary, it assumes that the service provider is a specialist in its particular field and makes use of the resources made available by the service provider, including its searching capability, being it proprietary or not. Various embodiments of the invention make use of the results obtained by the internal capabilities of the service provider system, and enable merger or crossing of the results with results obtained from another service provider. In this context, another service provider may refer to a service of a different company, a different service provided by the same company, etc. The beneficial feature here is that these embodiments enable crossing or merging of datasets without regard to their original format or semantics.

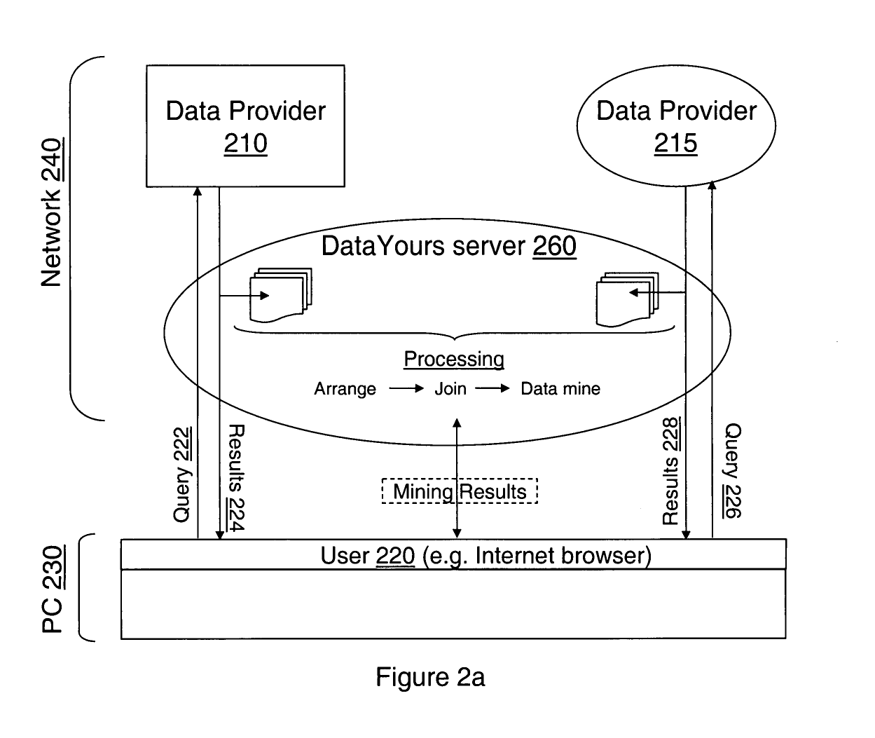

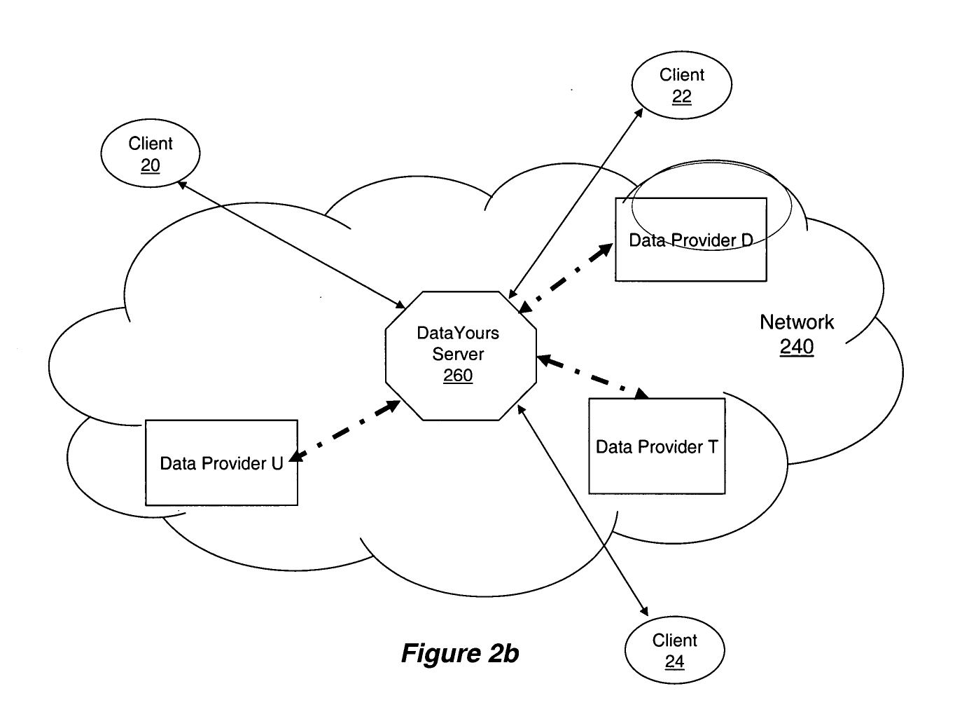

FIGS. 2a and 2b are conceptual illustrations of data mining according to embodiments of the invention. In FIG. 2a, user 220 can perform searches and data mining from data providers 210 and 215, via a single access point, referred to herein as DataYours™ server 260. Once the user 220 access the DataYours server 260, the user 220 is able to see the type of data that is made available by each data provider 210 and 215. The user can then formulate queries 222 and 226, for data providers 210 and 215, respectively. The query page for each data provider is obtained from the data provider each time a query is to be made, so that the user sees the latest, most updated query page. The queries 222 and 226 are submitted to the respective databases via the DataYours server 260, and the results 224 and 228 are returned to the DataYours server 260. The results are arranged at the DataYours server 260 to conform to a predetermined standard, so that any dataset obtained from one data provider can be crossed with a dataset obtained from another data provider. The user can then view the results via the DataYours server 260, perform operations on the results, such as joining the returned datasets, and mine data from the returned and/or joined datasets.

As can be understood from the example of FIG. 2a, since no data processing needs to be performed by the user's machine, e.g., PC 230, the user does not need to know the data structure of any database and does not need to perform any transformation of data or fields in order to operate on the datasets. This enables the user to easily cross any dataset from any data provider with any other dataset from the same or different data provider, a process that would otherwise require ad hoc programming. This scenario is exemplified in FIG. 2b. In FIG. 2b, Data Providers D, T, and U maintain databases that are made available for access through network 240, such as the Internet or an intranet. A DataYours server 260 is capable of accessing any of the databases of the Data Providers D, T and/or U. A user, such as any of clients 20, 22 and/or 24 wishing to mine data from any of the databases access the DataYours server 260, as illustrated by the solid-line double-headed arrows. Any of the users can then submit queries and obtain datasets via the DataYours server 260 from any of the databases D, T, and/or U, as illustrated by the dotted-broken line arrows.

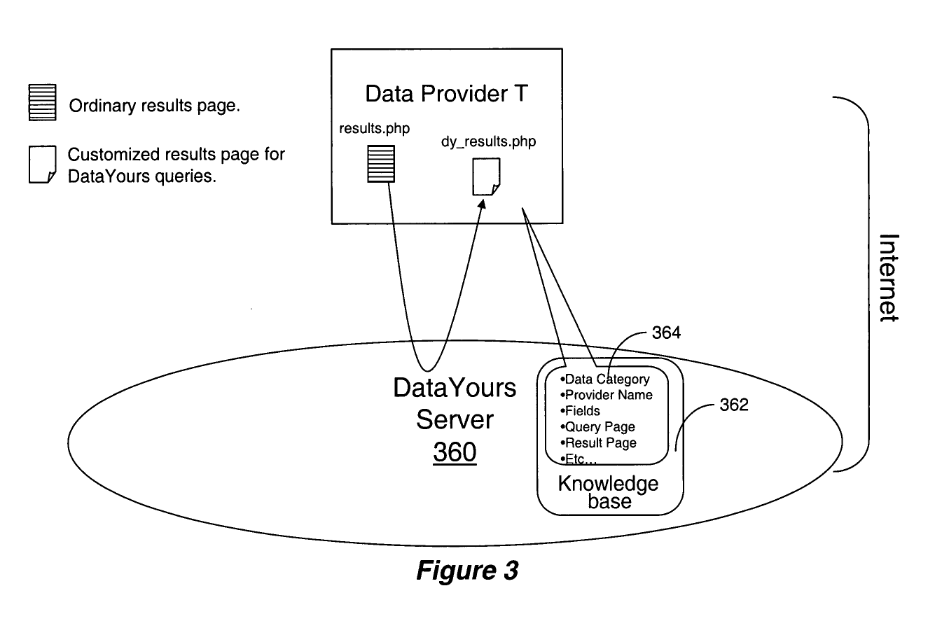

FIG. 3 illustrates an interaction between a data provider and a DataYours server 360 according to an embodiment of the invention. To provide data services via DataYours server 360, a data provider, such as Data Provider T, registers with the Data Yours server 360. During the registration process, knowledgebase 362 of DataYours server 360 is updated to include information relating to the Data Provider T. This can be done by having the registering data provider enter appropriate data on a registration webpage of DataYours server 360. The data that may be collected may include, e.g., data category (e.g., medicine, sports, news, etc.), provider's name, the fields that are used in the provider's output/results page, the URL to the query page, and the URL to the results page, as illustrated in 364.

When a data provider registers with DataYours server 360, the data provider need not change its own data base, search engine, or website appearance. However, the data provider adds another page to its service. That is, the data provider usually has a result page that is normally presented to users after entering a query for the database, as illustrated by page results.php. After registering, the data provider search engine continues its operation as normal; however, it has two channels to provide the results. When a user submits a query from the data provider's service, the query includes the normal indication to provide the results using the normal results page. However, if the query page is submitted by the DataYours server, then the DataYours server modifies the query prior to submission to direct the query to a modified result page that follows the format provided by DataYours during the registration, here illustrated by dy_results.php. The format of the secondary results page, dy_results.php, is dictated by the DataYours server 360. The URL to the dy_results.php is also added to the knowledgebase 362. The type of processing included in the data provider's system doesn't affect the DataYours server's operation. Meaning, the data provider's query point can be the interface to: a web service (e.g. SOAP), a cgi module, or any other type of server element receiving the query parameters and producing data output in the results page. DataYours acts on the output data.

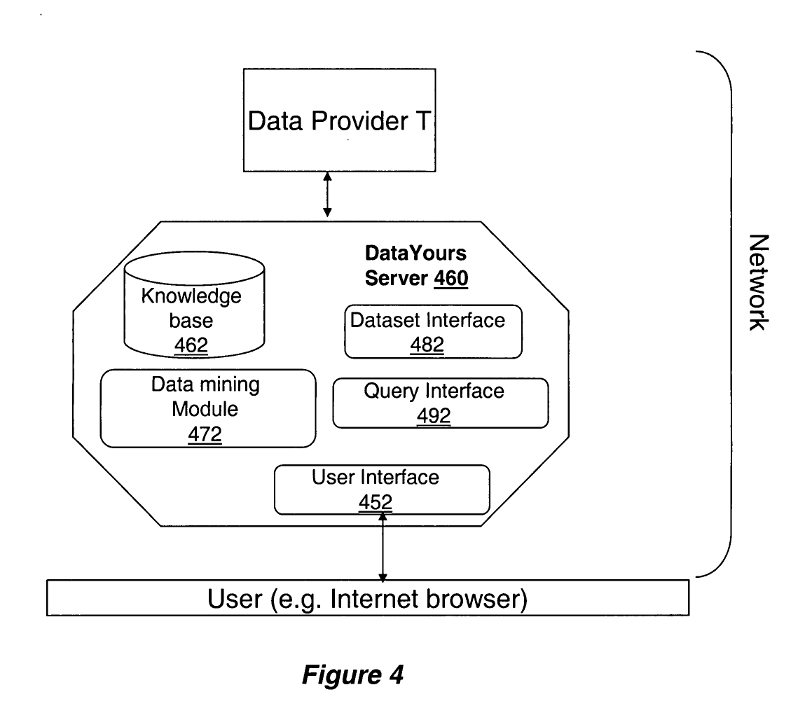

FIG. 4 depicts an example of the main elements of a DataYours server 460 according to an embodiment of the invention. In general, the DataYours server 460 comprises four main elements: a knowledge base 462, a data mining module 472, a dataset interface 482, and a query interface 492, which are accessible and/or operable via the user interface 452. These elements will now be described.

Knowledge base 462 stores information of data providers and semantic interrelations. The information of data providers is similar to that illustrated in FIG. 3, element 364. However, no actual data from any database of any service provider needs to be stored in knowledge base 462. The advantage of the knowledge base 462 can be understood from the following. When a user tries to join or merge data from different data providers, according to the conventional method the user has to visit the website of each data provider and inquire what kind of data is available from the data provider's database. Moreover, unless the user is aware of the existence of the database of a certain data provider, the user will not know to visit that website to look for available data. On the other hand, using the inventive knowledge base 462, the user merely needs to visit DataYours server 460 to find all service providers who provide data relating to a chosen category, and see all the data fields available in the database of the service provider—all without having to visit a single service provider website or download a single dataset. Also, this provides the user with a sort of a “clearing house” of all databases available for a particular category. Therefore, the user need not know beforehand who are the service providers who make data available in a particular category, nor the relations between different Data Providers in order to join datasets.

The data mining module 472 enables merging and/or joining of various datasets of data obtained from various databases of service providers. Notably, according to an embodiment of the invention, joining datasets can be done even before any query is submitted and/or any data is fetched from any data provider. That is, since the fields of each output page of a data provider are listed in the knowledge base 462, a user can set up various merging or joining operations of various datasets from the listed data providers and their fields. Only when the user is satisfied with the databases and fields to be merged, the data needs to actually be fetched from the selected databases. This enables the user to plan an entire research scheme without having to spend any time, bandwidth, or processing associated with downloading data. Only when the entire research scheme is completed, the user can instruct the DataYours server 460 to actually go and fetch the data.

Dataset interface 482 processes data and renders it into record sets. The dataset interface receives results returned for a user's query in the form of the customized results page, e.g., dy_results.php. The dataset interface 482 then process the results into a dataset file.

The query interface 492 enables the user to interact with the data providers' query page through the DataYours server 460. Notably, the original query page of the service provider need not be modified in any way to enable this interaction. Rather, when the user wishes to interact with a chosen database, the DataYours server 360 connects to the respective service provider's website and present the query page of that website to the user. In this manner, the query form that is presented to the user is the current, up to date, query form of the service provider. When a user submits a query, the query interface 492 changes the query submission URL from the data provider's regular URL, to the DataYours server's URL. According to an embodiment of the invention, the query is registered in the DataYours server 460 and, in a specific embodiment, the query is registered with respect to the specific user's folder and/or session. This enables the user to return to the DataYours server 460 at a later time and find the query previously submitted. After a query is submitted, the results are fetched by the DataYours server 460 from the customized results page, e.g., dy_results.php, rather than from the original results page, e.g., results.php. The results are presented to the user according to DataYours server 460 format, rather than according to the service provider's format. Optionally the User is able to be presented with the ‘regular’ results page as well. That's possible because all the necessary query parameters are recorder, and are the same for either presentations (regular and dy_pages). Although presenting the ‘regular’ page is not necessary for the data mining aspect, DataYour's ability to display that adds power to its User Interface. In other words, the User doesn't lose the ‘regular Data Provider’s graphics' feature when he/she uses DataYours.

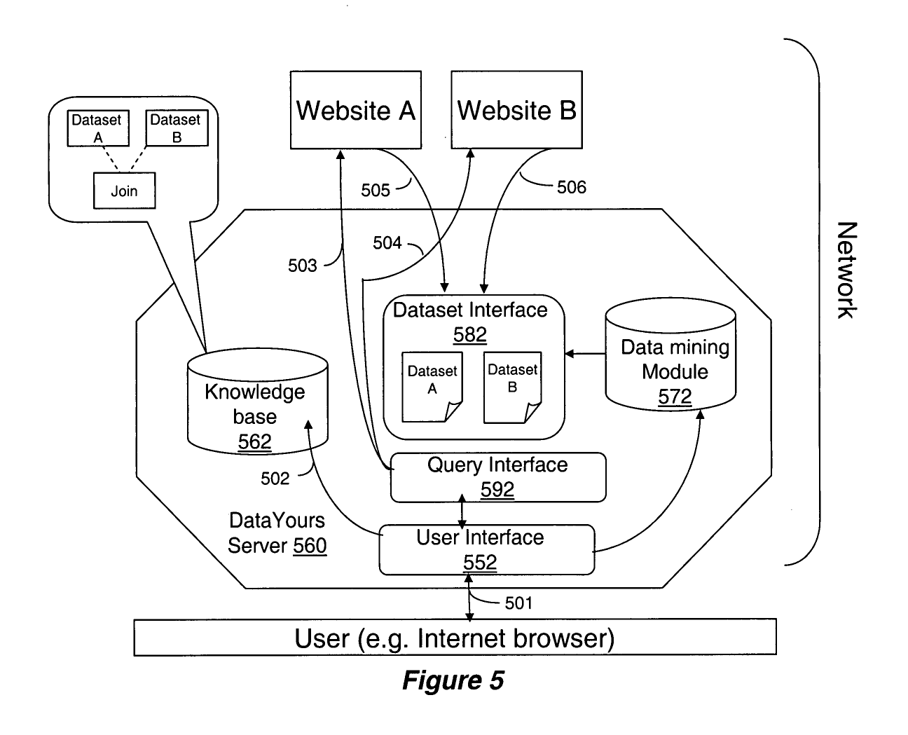

FIG. 5 is a conceptual diagram illustrating a process flow for data mining according to an embodiment of the invention. As shown in FIG. 5, all interactions of the User are with the user interface 552. The User Interface then interacts with the various internal modules and/or interfaces. Here, the user may access the query interface 592 of DataYours server 560 via the user interface 552, as illustrated by double-head arrow 501. The query interface 592 acts as a proxy to the data provider query interface, The user may also utilize the user interface 552 to access the information in knowledge base 562 to decide on a data mining strategy, as shown by arrow 502. In this example, the user decides to join dataset A (from website A) with dataset B (from website B), as shown in the callout. As noted before, the user can decide on the strategy, the data bases, and the datasets to be used without having to go to the other websites or submit a query to these websites. This is because knowledge base 562 contains the information of which website maintains what database, on what subjects, and having which fields.

Once the user makes a decision on the mining strategy, the user instructs the DataYours server 560 to perform the mining operation. As noted above, the query to be sent to each website is saved in the DataYours server 560, and is also sent to the respective websites, using the query page URL that is stored in the knowledge base 562, as illustrated by arrows 503 and 504. The results of the query are fetched from the customized results page, and are delivered to the dataset interface 582, as shown by arrows 505 and 506. The dataset interface 582 transforms the results into datasets A and B, to enable the data mining module 572 to perform the mining operation, in this example a joining of datasets A and B.

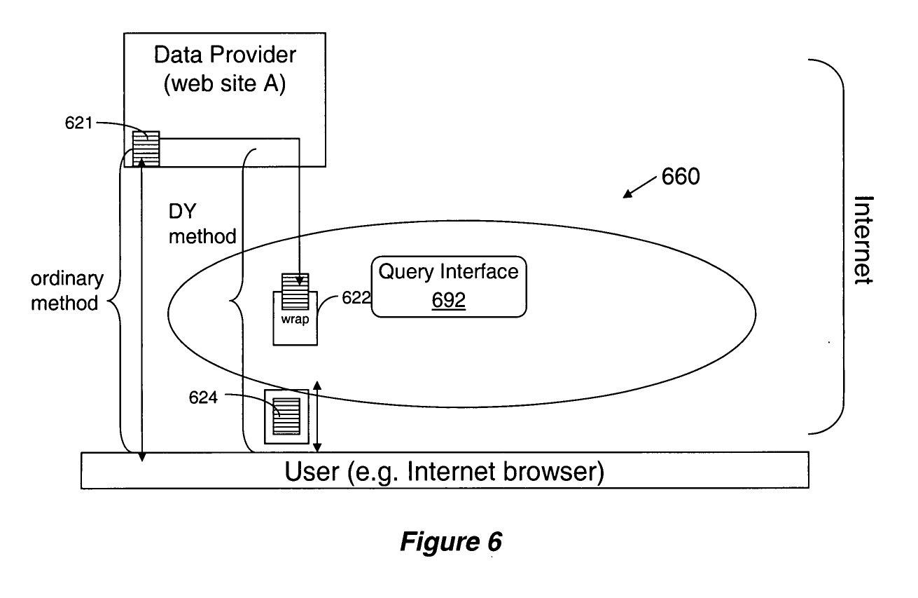

FIG. 6 depicts query submission comparison between the prior art method and according to an embodiment of the invention. As shown in FIG. 6, in the ordinary prior art method, the user access the data providers' website A, and access a query form 621. The user then uses the form 621 to submit a query. On the other hand, according to an embodiment of the invention, when the user wishes to submit a query via the DataYours server 660, the query interface 692 of DataYours server 660 fetches the query page 621 from the website A, wraps it in DataYours envelop 622, and presents the wrapped query page 624 to the user via the user interface (not shown). Among other action, the wrapper changes the original submission URL with a DataYours server 660 submission URL. When the user enters the query and enters a submission command, since the original submission URL has been replaced with DataYours server 660 submission URL, the query will not be submitted to the data provider A, but rather will be submitted to DataYours server 660 and be received by the query interface 692. The query interface 692 registers the submitted query in the DataYours server 660, and also sends the query to the web site A. In this manner, from website A perspective the query originated from DataYours server 660 so that the results are to be delivered to DataYours server 660. Additionally, a record of all submitted queries is maintained on the DataYours server 660 for the user's future use.

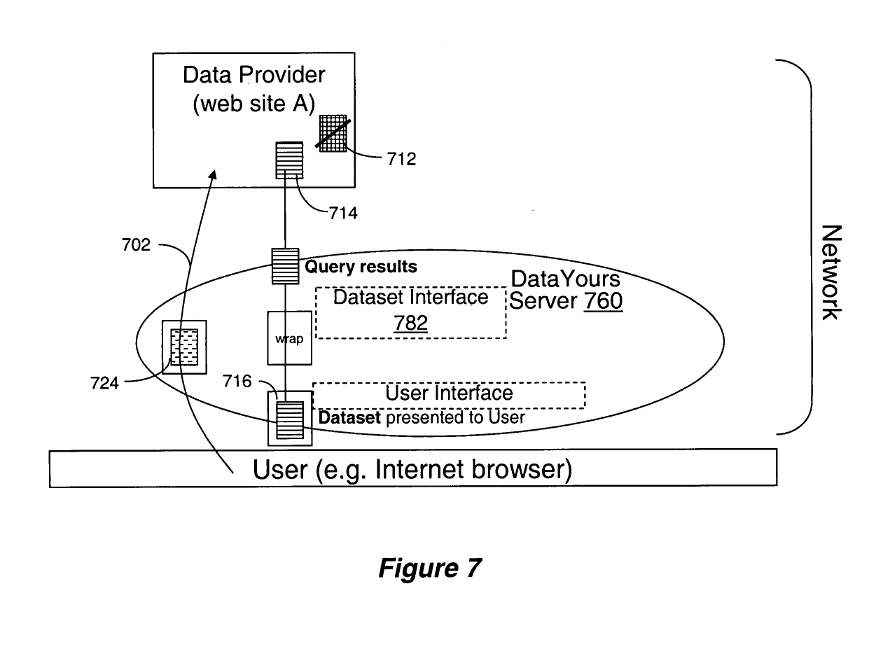

FIG. 7 depicts a method for fetching data results according to an embodiment of the invention. In FIG. 7, a user submits a query, 702, to data provider website A, using the wrapped query form 724. The query is registered in the DataYours server 760, and is also submitted to Website A. Website A processes the query and generates a customized results page 714, per the template obtained from DataYours Server 660. DataYours server 760 downloads only the customized results page 714, which is handled by the dataset interface 782. The dataset interface forms a recordset out of the fetched customized results page 714. The user interface then presents that wrapped recordset to the user 716.

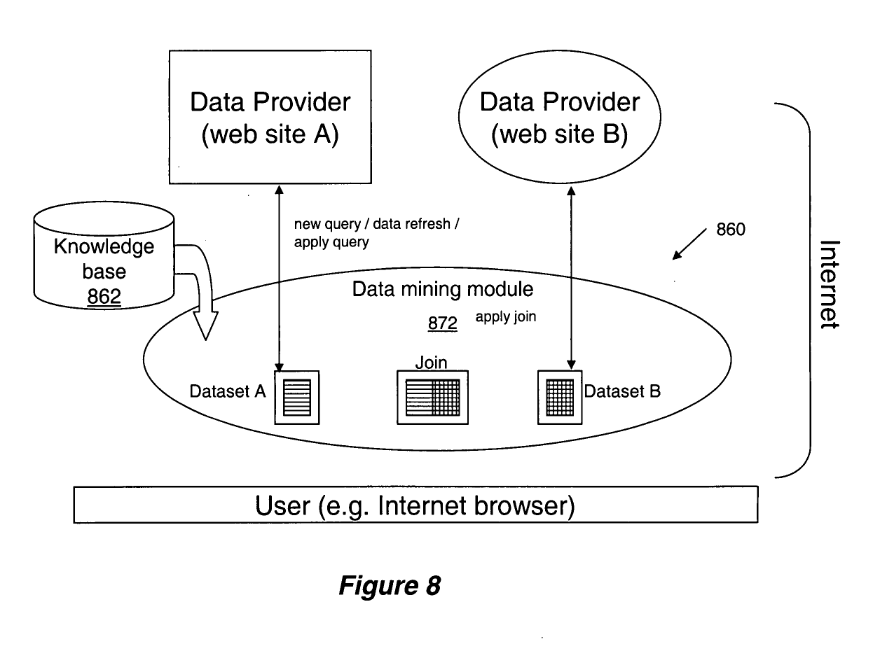

FIG. 8 depicts data mining according to an embodiment of the invention. As explained before, using aspects of the invention a user may design an entire research strategy from within the data mining module 872, without having to visit other websites, submit queries to websites, or download data from any website. Rather, using the data mining module 872, the user can determine what data is available from which website, by looking at the data from the knowledge base 862. Then, the user can form a data mining strategy by indicating what data to use, from which database to fetch the data, and what operation to perform on the data. In the illustrated example, the user determines to join dataset A from website A with dataset B from website B. Once the user completed his data mining strategy and submits a proper command, the DataYours server 860 fetches the data from the respective websites, organizes the datasets and performs the indicated operation on the dataset. Optionally, the User can fetch data in separate steps; for example, the user can get the query results from a first data provider, and only at the end get the records from a second data provider together with the joined records. Any combination of timing can be performed. According to another example the user may have datasets A, B, C, D, E from corresponding websites (no data fetched yet, just queries defined); and the strategy is to join all of them in the order of: A->B->C->D->E. Before joining the user may examine the records of any of the datasets, e.g., B and D, or the user may not care to see any intermediary records, just the final results, i.e. the joined set. As can be understood, while for simplicity a “join” operation is shown here, other operations can be performed, such as, e.g., sorting and searching within datasets, plotting various values presented in the datasets, applying various statistical formulae to the datasets or parts thereof, etc.

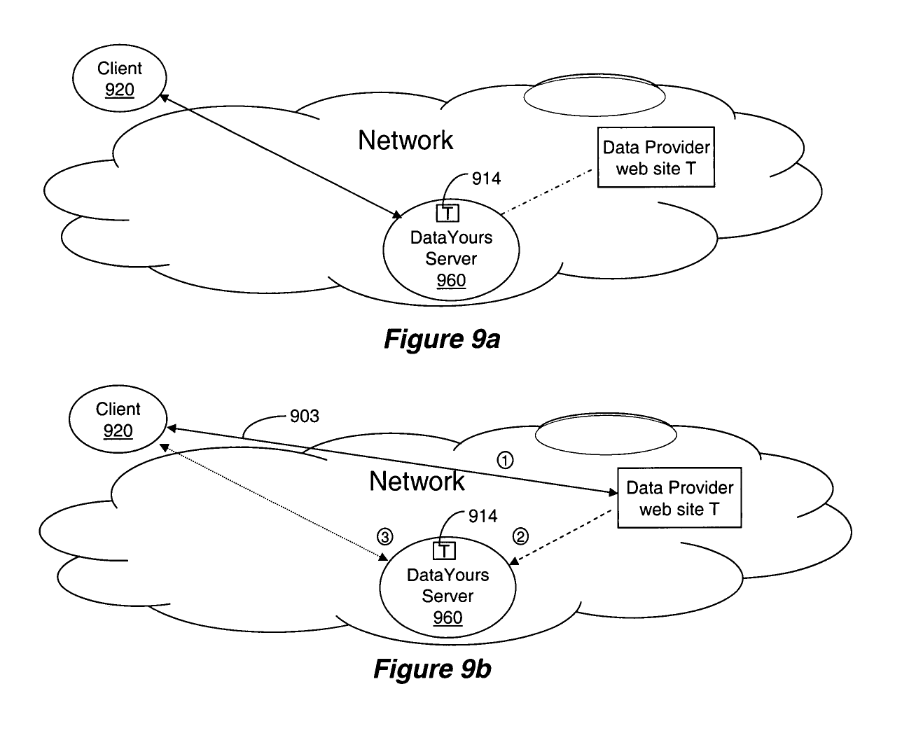

FIGS. 9a and 9b depict two ways in which a user can obtain data according to embodiments of the invention. In FIG. 9a, a user 920 accesses DataYours server 960 and submits the query on DataYours server 960. The query is then sent to Website T, which returns results 914. Results 914 are presented to the user 920, all much in the same manner as previously described. In FIG. 9b, on the other hand, the user 920 access website T directly and submits the query directly to website T, as shown by arrow 903. However, according to an embodiment of the invention, when website T obtains the results, rather then sending the results to user 920, the results are sent to DataYours server 960, and the user is directed to view the results on DataYours server 960. Alternatively, the website T may display the regular results page including an additional small icon saying “Send to DY.” When the user clicks the icon, the results are shown as a dataset in DataYours as already described. In the same way, the icon may appear in the query page, so that the user is given the choice to “jump” to DataYours earlier. In this manner, the user can create a personal folder in DataYours server 960 and direct to it results of various searches performed in various websites. Then the user can formulate and operate on the results to further mine the datasets obtained. In this embodiment, the user's folder on the DataYours server 960 can be thought of as a “results bank” in which the user collects results of various queries from various sources. According to one implementation, no data is stored in the DataYours server in a permanent state. Only the data providers' names, query commands and the data mining strategies are stored permanently. The user then has in his disposal all of the results and the ability to perform various operations of the datasets of the results.

As can be understood, the feature depicted in FIG. 9b can be easily implemented by providing the option by, e.g., an icon or drop-down menu, on each registered website of a data provider, enabling a user to select whether the results should be sent to the user's machine or to the DataYours server. If the user selects to download to his own machine, the normal results page is sent to the user's machine. If the user elects to send the results to DataYours server, then the user is directed to DataYours site and the customized results page will appear through DataYours interface.

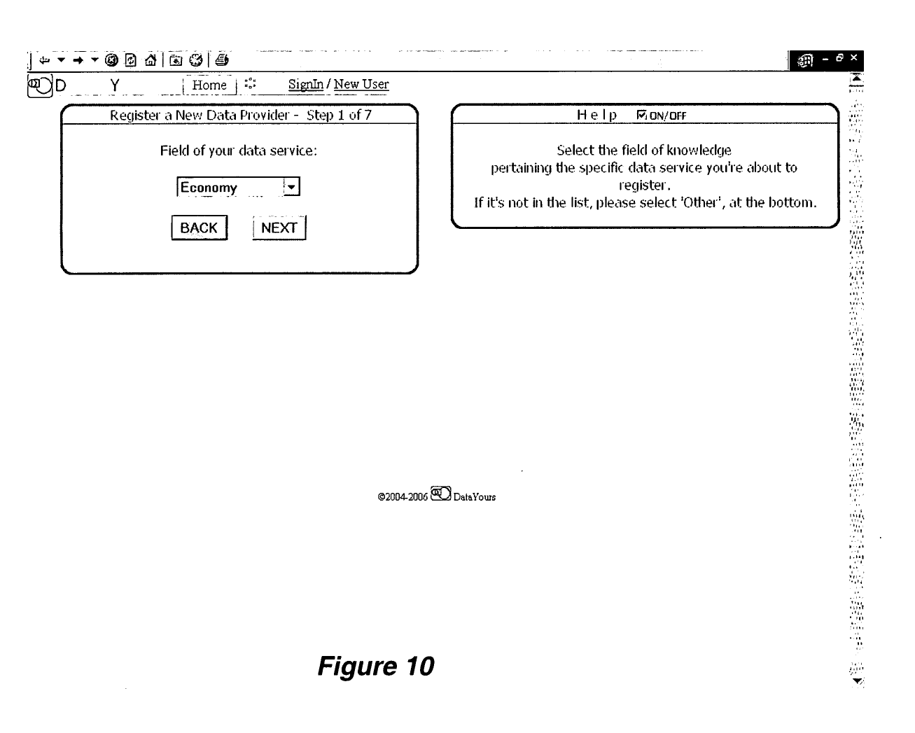

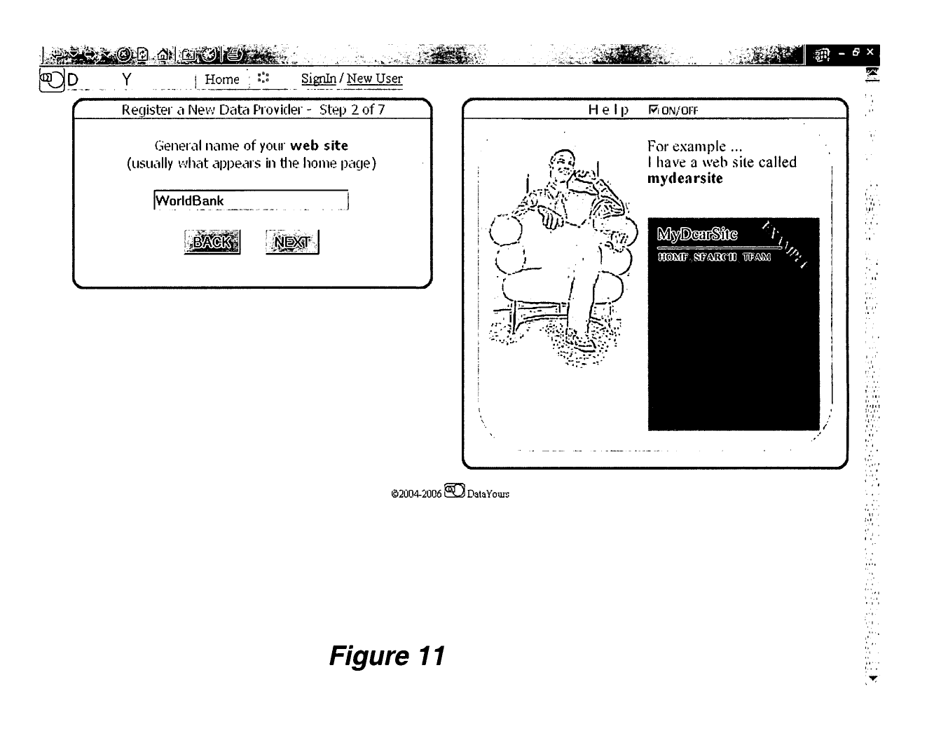

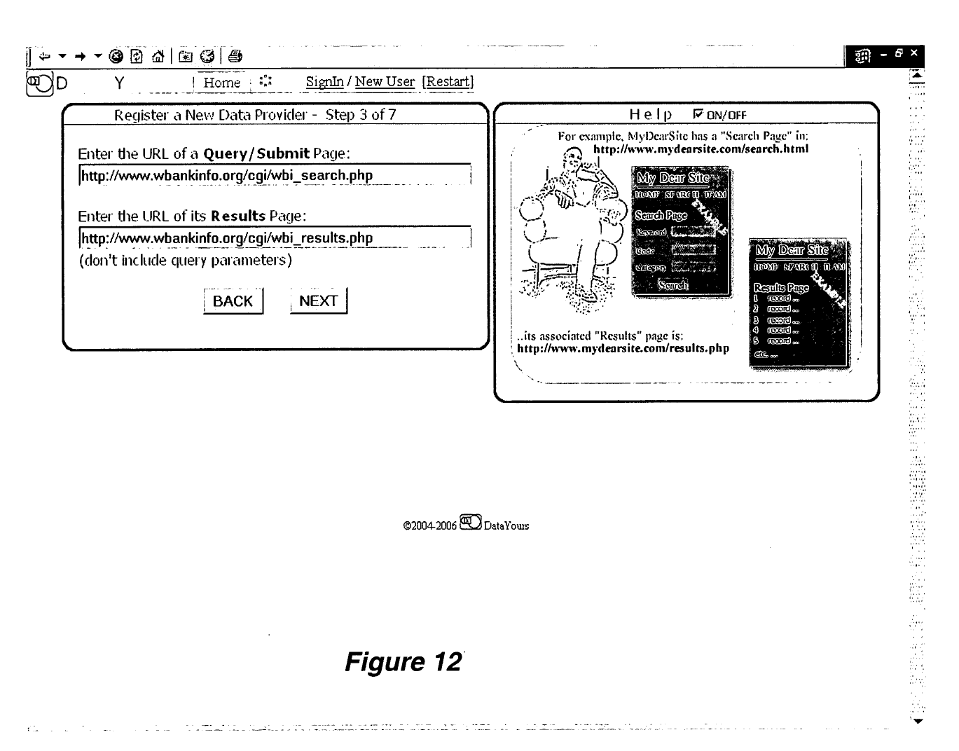

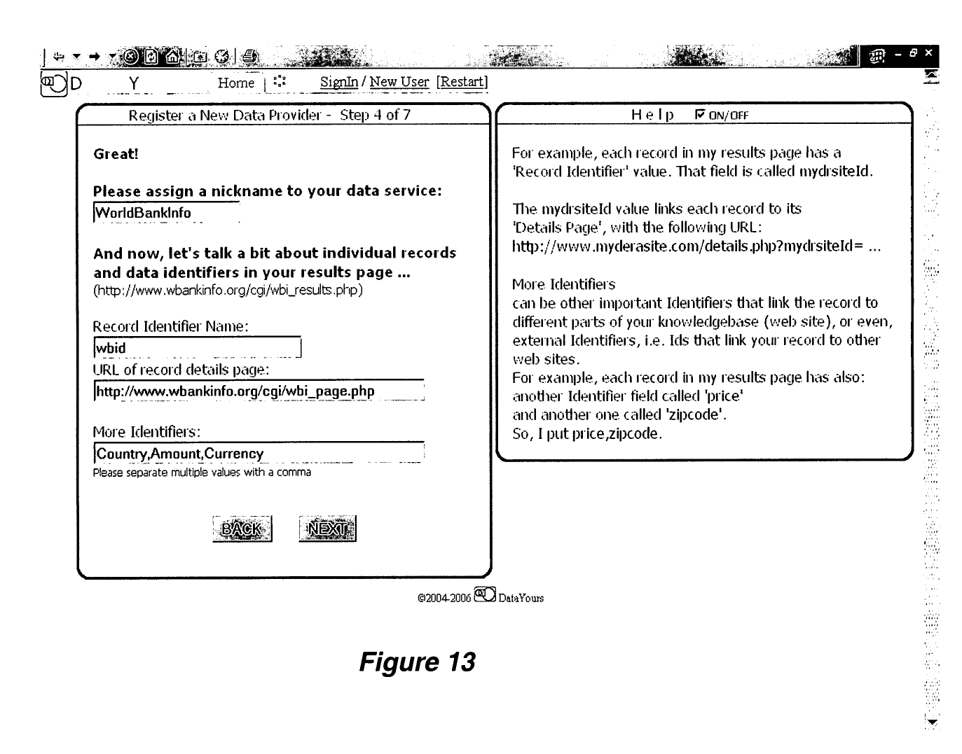

According to a feature of the invention, data providers wishing to enable data mining on their results pages are registered with DataYours server. The registration basically comprises two parts: defining the data services that the service provider enables, and creating a customized plug-in for the data service points. The definition of service process begins by asking the registrant to select a field of service from a drop-down menu, or to enter a new field that is not yet listed in the drop-down menu. An example is depicted in FIG. 10, wherein the registrant selected “Economy.” The registrant then enters a general name for the website, as shown in FIG. 11. The registrant is then asked to enter the URL of the query/submit page and of the results page, as shown in the example of FIG. 12. FIG. 13 depicts an example of the next step wherein the registrant enters information about the data and the data fields. Here, the registrant enters a name for the data service, e.g., WorldBankInfo. Then the registrant enters a record identifier name. In this example, wbid. The record identifier name is the generic part of the name that may apply to all records in the database. For example, for a database having technical publications in the medical field, a record identifier name may be, e.g., PubMedID; while each specific record may have the name PubMedID###, where the pound sign indicate a specific number of the publication record. Note, however, that the semantics of the field name is just the variable name; it's not related to the actual value in the field. For example PubMedId is the variable name and one value can be 213475 (by coincidence, in fact, PubMedIds are always numeric text). The same principle goes for all the field names DataYours registers from the data providers record. What DataYours calls “RecId” is that record (optional) field/variable that, in addition to assigning a value to the record, that value, added to the generic URL, forms a link to the record's details page. The registrant also enters the generic URL of the record details page.

In the “More Identifiers” window, the user enters field identifiers of the records. In this example, the entries are comma delimited to enable entering several identifiers in the same window; however, other methods can be implemented to enable multiple entries, such as multiple drop-down menus, etc. The entries in the “More Identifiers” section is the part that helps overcome the semantics problem of the prior art that prevents joining datasets from different databases. That is, when the registrant enters a field name, various methods are used to enable convergence of terms by the various registrants. For example, when the registrant starts to type a field name, existing fields that start with the same letters appear, from which the user may chose the proper name, or continue to type a new name. Also, a table of synonyms may be used to suggest to the registrant existing names that are synonym with the name the registrant enters. For example, if the registrant enters the field name “cars,” the synonym table may include the terms “automobile” “vehicle” etc. If one of the terms is already used by others, the system can suggest the user the term that has already been used and allow him to choose one of the already used terms. Additionally, a record can be stored detailing which registrant used which terms. In this manner, when a term is offered to a new registrant, the system can also show to the new registrant who are the previous registrants that have already used that term. In this manner, if the new registrant recognizes the previous registrant, it may increase his confidence to use the term, or help him decide on a different term so as to differentiate from the other registrants. In this manner, a knowledge base is built by the entries of the various registrants that enables recognition and linking of data fields, even if different registrants call them different names. It should be noted that under one embodiment of the invention, the entry in Record Identifier Name is also used as one of the terms in the “More Identifiers” list and is used in the same manner as the terms in the “More Identifiers” list.

In respect to overcoming the semantics problem, here the semantics issue is not only or necessarily lexicon or language based, but is rather (data) field naming based. That is, beyond the problem of having various words in any given language that can be used to call a certain item, for example, zip code, postal code, etc., there is also the issue of specific usage of names for data fields and records in database. For example, for technical publications, some databases may have records names such as “PubNo,” “PubID,” “PaperID,” etc. Such different names need to be recognized as overlapping when appropriate and entered in the synonyms table. In fact, some such record names become commonly used in specific industries, such as, e.g., PubMedID, ISBN (Internationl Standard Book Number), etc., and are also cross-linked to enable data mining. For example, ISBN numbers can be linked to Library of Congress Catalog Card numbers.

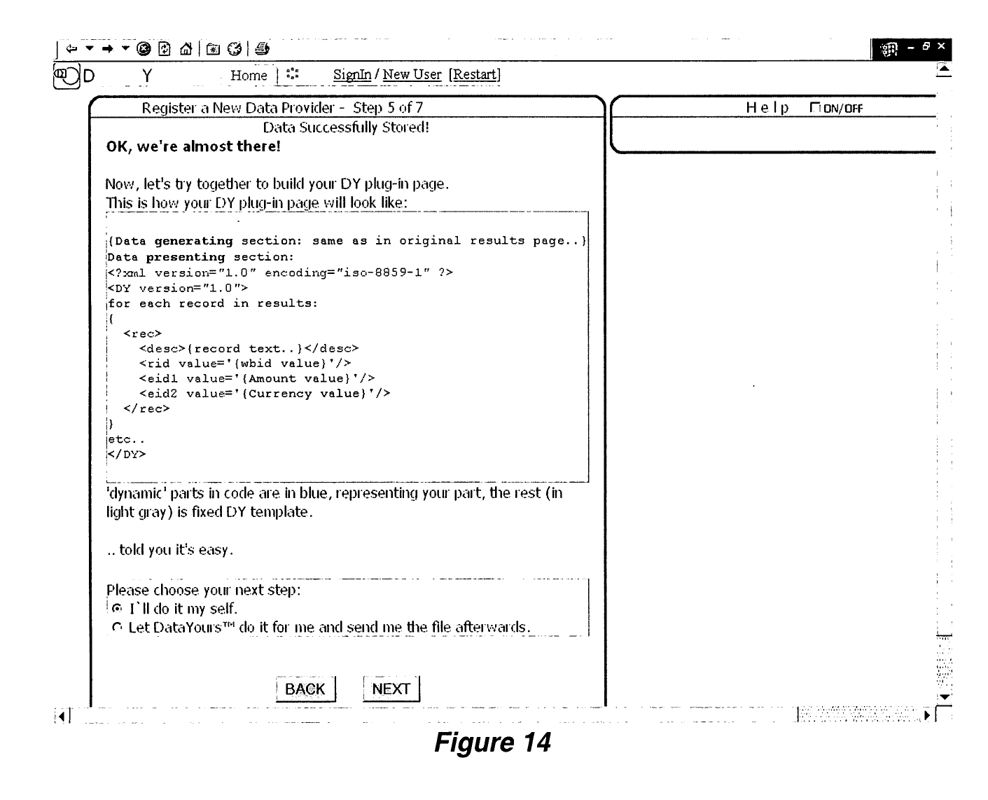

FIG. 14 illustrates an example of creating a customized results page according to an embodiment of the invention. The typical server-side code of a results webpage generally comprises two sections: data generating section and data presenting section. The data generating section is the part of the webpage code that gathers all the information from the data source (e.g. database). This part remains the same as prior to registration with the service. The data presenting section is the part of the code that writes the data on the page and provides the proper layout of the page on the monitor's screen. For the customized results page, the original data generating section remains the same, and the original data presenting section is replaced by a template that generally removes all “aesthetic” attributes of the original page and present the data in a simple tabular format. In this manner, regardless of which website the query is made, the customized results page will always have the same format and the DataYours server will always be able to read it in the same manner with the same fields, order of fields, and entries. Isolation of the data provider's data generating section from the scope of DataYours, makes DataYours non-invasive to the data provider system, on one hand, and focuses the mining process on the important aspects of the data production (the results), on the other.

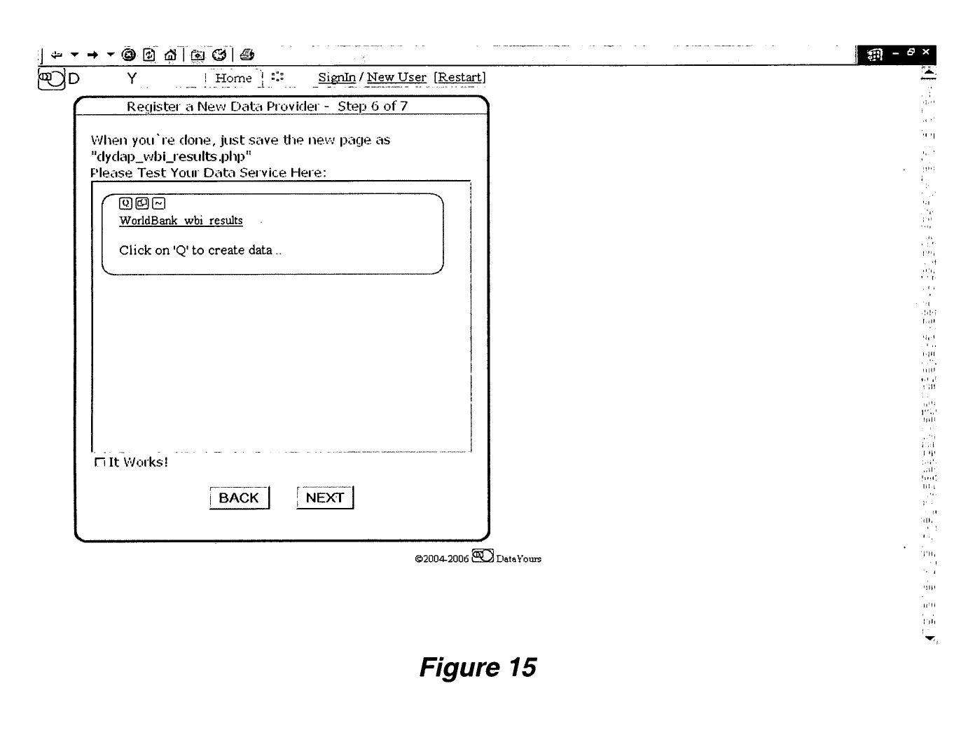

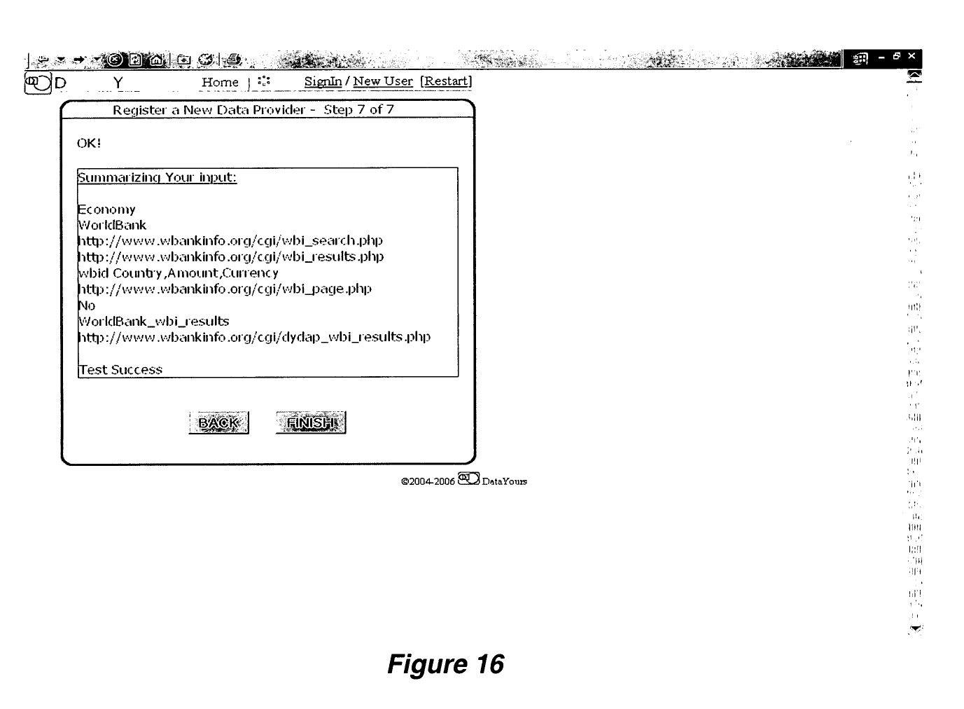

FIG. 15 depicts a page that enables the registrant to test the working of the customized results page, while FIG. 16 depicts the page for finalizing the registration according to an embodiment of the invention.

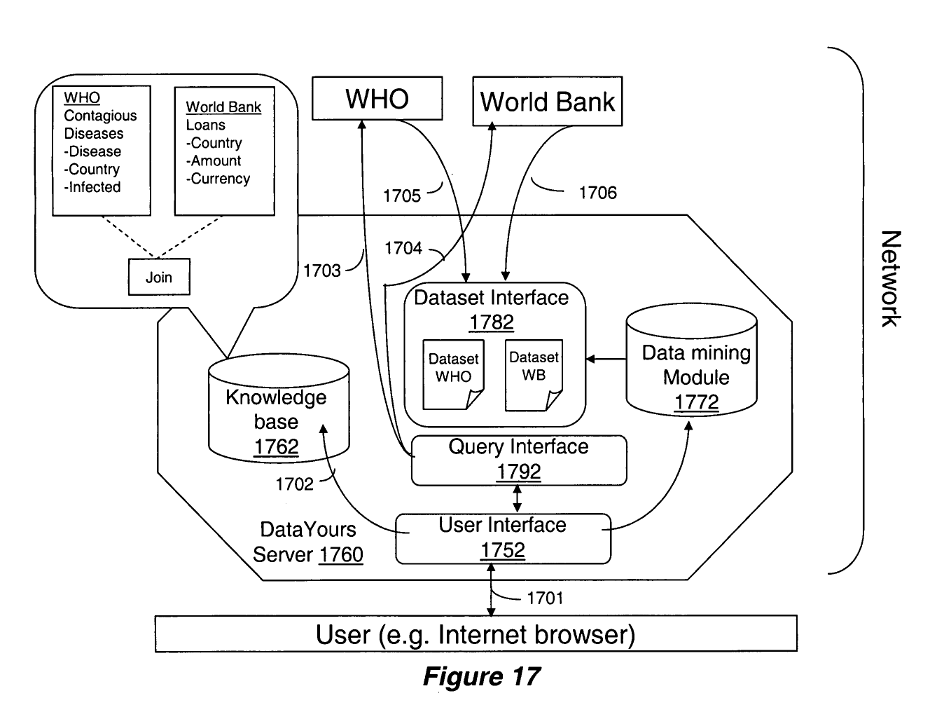

FIG. 17 depicts an example of data mining process according to an embodiment of the invention, while FIGS. 18 and 19 illustrate screenshots of two points in this process. In this example, it is assumed that World health Organization (WHO) and the World Bank have registered their databases with the DataYours server 1760. The user in this example would like to compare the loan amounts provided to countries and the rate of contagious diseases in these countries. As can be readily understood, since the WHO and the World Bank are two separate entities who maintain their own separate databases, in the prior art such an operation would be very complicated and time and resource consuming. However, as will be demonstrated here, using this embodiment of the invention such an operation is very easy to perform. The user first connects to the user interface 1752, as shown by arrow 1701. From the user interface the user can access the knowledge base 1762 to see that WHO is registered service provider that maintains a database having records for contagious diseases with fields: disease, country, infected. The user can also see that WorldBank is also a registered service provider having a database with records named “loans” and fields: country, amount, currency. This information was obtained by the DataYours server during the registration process, as outlined above. However, as can be understood from the subject disclosure, the mechanics of the joining operation remains transparent to the user, which doesn't need to know even about the matched fields between the datasets (e.g. “Country”). The goal is to make the user feel he can freely integrate (join) datasets, as if anything automatically ‘links’. Only on occasions when the requested join is not explicitly reflected by the DataYours knowledgebase, the user is asked to ‘manually’ set the matching fields to base it on (for example, “Age” in dataset A to “Retirement Age” in dataset B).

The user can then select the information the user would like to get from the WHO and World Bank databases. FIG. 18 illustrate a screenshot for an example where the user sees a wrapped query page of WHO dataset and can select one or more of the particular diseases the user would like to obtained information about. Once the user selects the desired information, the selection forms a query. A similar screen is provided for the user to select information from the World Bank database. A feature of the invention is that the data provider's query page always comes ‘fresh’ from the data provider's site. That is, query and results are separated and independent elements, and DataYours server's operation is automatic, as long as the dy_results page (i.e., the data access point DAP) structure is not changed. At any second the data provider site can change the appearance of that query page, without affecting DataYours server's functionality. However, if the data provider decides to change its DAP fields, then it needs to update its profile in the DataYours knowledge base accordingly. As can be understood, while this embodiment shows only two data providers, any number of data providers can be selected by the user in a similar fashion.

After the user selects all of the desired information from the respective data providers (i.e., forms all the required queries), the user can indicate what operation to perform on the data set obtained from the data providers. In this example, the user selects a “join” operation. It is important to note that up to this point, all of the operations described were performed by the user accessing only the DataYours server 1760, and no access (except for fetching the data provider's query page) or data was required from either the WHO or World Bank websites. In this manner, the user can formulate the entire data mining strategy from a single point of access without having to download any data while still using each data provider's particular web query interface. From the data provider's point of view, its query/search interface increases in emphasis, exposure and relevance on the Internet, when used through DataYours server. Once the strategy is ready, the user can submit the request to the DataYours server 1760, upon which the queries are sent to the WHO and World Bank websites, as illustrated by arrows 1703 and 1704. The results data is then fetched from the WHO and World Bank websites, as shown by arrows 1705 and 1706, in the form of the customized results page that followed the template provided by the DataYours server 1760. As explained previously, since the data is provided arranged according to the template, the dataset interface 1782 can easily arrange the results into datasets with the particular fields defined in the template. Then, the data mining module can perform the requested operation, in this example, joining the two datasets. This is shown in FIG. 19, wherein window 1905 shows the data obtained from the WHO database, window 1910 shows the data obtained from the World Bank database, and window 1915 shows the results of the joining of the two datasets of 1905 and 1910.

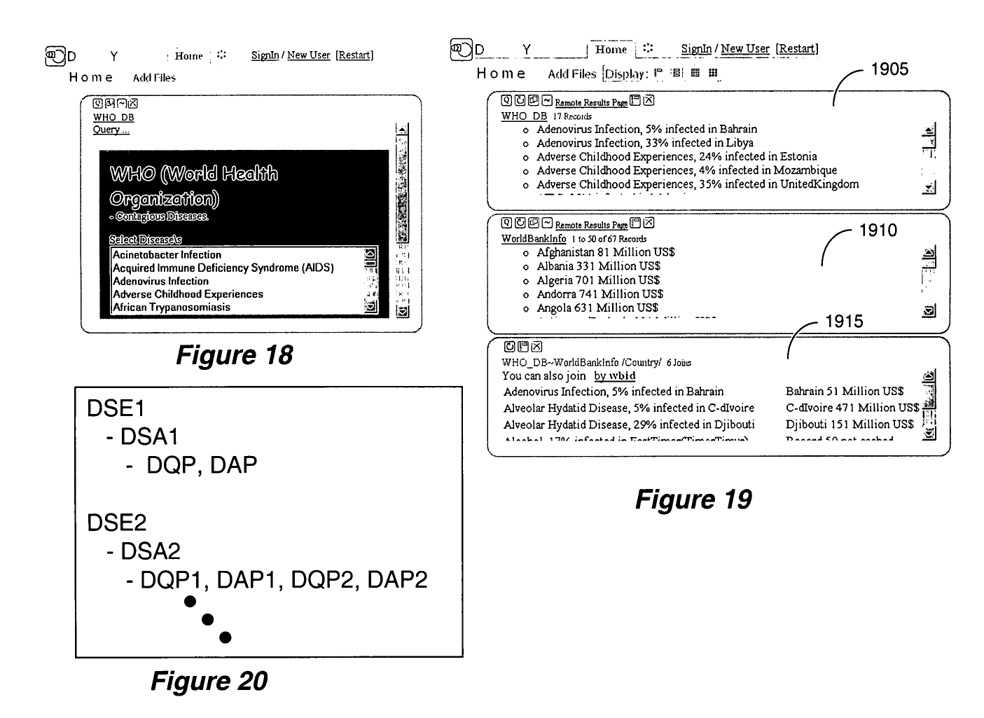

According to an embodiment of the invention, the Web is structured so as to provide certain order to information available from various data providers accessible from the Web. FIG. 20 depicts an embodiment of Web categorization according to an embodiment of the invention. According to this embodiment, the top level categorization is called Data Sharing Environment (DSE). The DSE categorization is an organization by subject matter, e.g., economy, law, geography, etc. In this manner, each data provider is categorized under one of the DSE's. In the embodiment of FIG. 10, this is done by requiring the registrant to indicate or select one DSE that best describes its data services. Then the registered data provider can be associated with the selected DSE.

The next level categorization is called Data Sharing Application (DSA). These are the specific data service providers, e.g., CNet, WebMed, Yahoo, etc. According to this embodiment, each DSE would have one or more DSA's associated with it. In this way, when a user selects a DSE, the system can immediately show the user who are the data providers (DSA's) that have data providers relating to the DSE subject matter. Therefore, when a user wishes to research a certain subject matter, the user need not know beforehand who are the data service providers who have data providers relating to the specific subject matter of the research.

For each DSA the system associates a data query point (DQP) and a data access point (DAP) (DSA can have more then one DAP or DAP/DQP pair. This is actually more common, since a medium size web site has more then one search/submit-query page). DAP is the customized results page (also called “DY plug-in page”). DataYours names the regular results page, “DPP”, Data Presentation Point. So, in terms of pages (URL): before the registration with DataYours server, a data provider has a DQP and a DPP, after registration it has: same DQP, same DPP and a (new) DAP. The DPP is also registered in the profile.

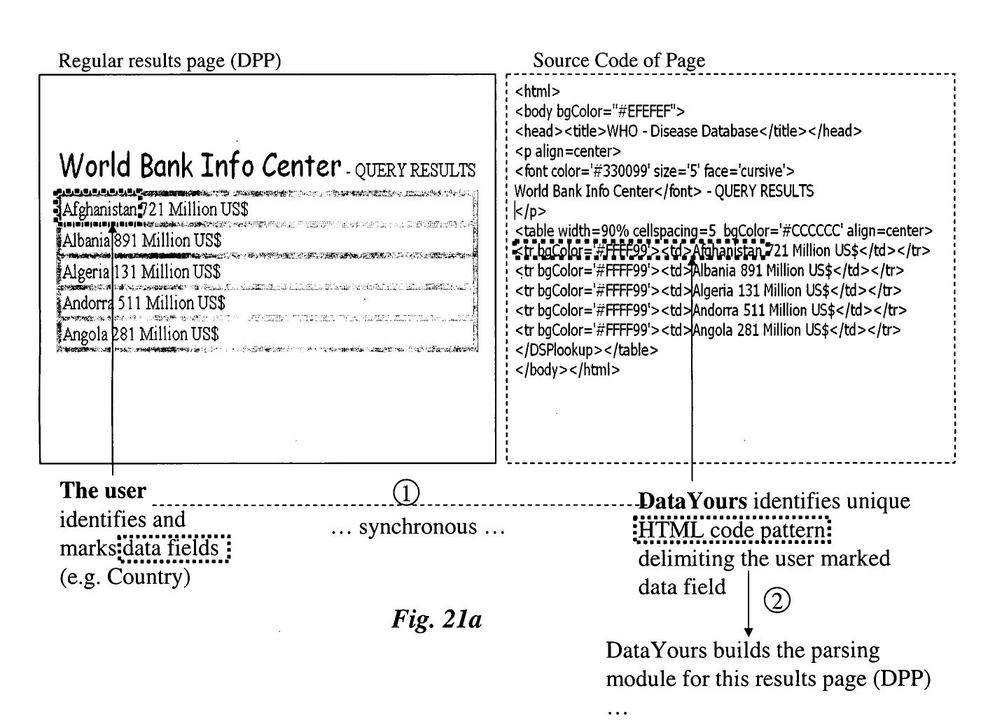

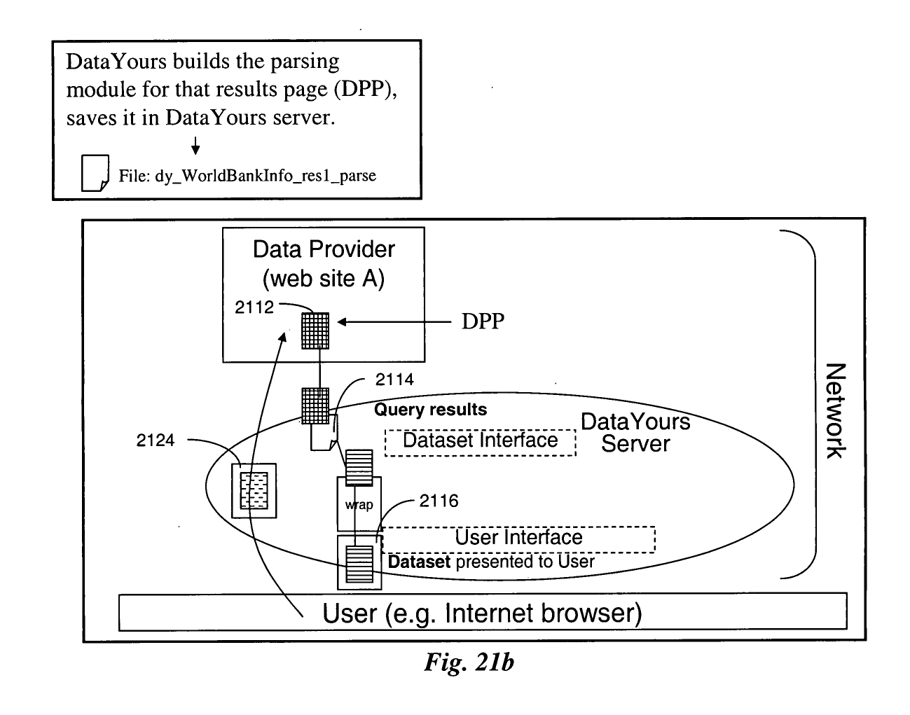

An embodiment of the invention provides an additional method, described here in the form of an interface, for the registration of a data provider output page, referred to herein as “express registration.” This interface lets a user define the customized results page on the fly. This embodiment is most useful when a user would like to use the features enabled by DataYours server, but the data provider of interest is not yet registered on DataYours server. The user first needs to obtain the URL for the data provider's query page. The user then enters this URL in the user interface of the DataYours server. DataYours server then fetches the query page from the data provider and presents it to the user. However, the query interface does not change the query page to point to a customized results page, as no such page exists until the data provider registers. The user enters a query in the presented query page, and the query interface directs the query to the normal results page of the data provider. When the results are returned, they are presented to the user, as shown in the left hand side of FIG. 21a.

As can be seen in FIG. 21a, the user is then asked to identify the relevant data fields of interest though an interactive online interface. In this example, the user identifies “Afghanistan” as a data field of interest and marks the field as, e.g., “country.” As shown in the right hand side of FIG. 21a, the DataYours server then identifies the unique tags patterns code adjacent to each field in the page source code, and builds a parsing script module for this specific results page. This customized results page is stored in the DataYours server and can now be applied directly to any regular results page from this data provider to convert the normal results page output into DataYours format. The converted output is then used exactly the same way DataYours customized results page (see, e.g., 714 of FIG. 7). This is illustrated in FIG. 21b, wherein the DataYours stores the parsing module for the regular results page of a specific data provider (web site A). Then, whenever a user submits a query 2124 to the data provider, the normal results page 2112 is returned, as no customized results page resides in the data provider's server. The parser module 2114 is then applied to the results page 2112 to fetch the data corresponding to the data fields in the parser module, and the results are wrapped and presented to the user as 2116. The user may then operate on the results in the same manner as described before with reference to other embodiments.

The main difference between the DataYours customized results page and the DataYours parser module is that the latter is issued without the need of any involvement of the data provider. Also, the DataYours parser module is not saved in the data provider's server. The purpose of the ‘express registration’ path is to enable usage of DataYours features on any available data provider, whether registered or not, by enabling all Internet users to link any data providers to the DataYours server.

As can be understood, for proper operation the ‘express’ mode should not completely replace the DataYours customized results page method, in which the data provider is actively involved. The main reason for that is that the data fields can only be added/managed by the data provider. The user of the ‘express registration’ is limited to the fields presented in the regular results page. Therefore, there may be occasions where a data filed is not included in the output, but the data provider may include it. For example, the data provider may want to add a field ‘DocId’ in the DY formatted output, where normally it is not included in the regular results page of this data provider (e.g., it's not needed). Therefore, enabling both methods for registration provides improved results. Moreover, the ‘express registration’ method constitutes a powerful tool for a “startup registration” of a data provider's output page to DataYours service.

With respect to adding data fields, there are occasions where a particular query would return a result that does not encompass all of the available data fields from the particular data provider. Therefore, when another query is submitted (after the express registration has been completed), the query interface checks the returned results page to see whether it includes fields that are not already associated in the parsing module. If so, the additional fields are presented to the user to be identified and added to the parser module of that particular results page.

Thus, while only certain embodiments of the invention have been specifically described herein, it will be apparent that numerous modifications may be made thereto without departing from the spirit and scope of the invention. For example, while the embodiments speak in terms of joining two data sets, any number of data sets can be joined using the invention. Further, certain terms have been used interchangeably merely to enhance the readability of the specification and claims. It should be noted that this is not intended to lessen the generality of the terms used and they should not be construed to restrict the scope of the claims to the embodiments described therein.

What is claimed is:

1. A method for enabling data mining from data providers, comprising:
maintaining a knowledgebase, said knowledgebase storing information of a plurality of data providers and an ordered list of data fields for each respective data provider;
for each respective data provider, providing a template for a customized result page, said template reflecting the data fields of the ordered list of the data fields;
providing an interface enabling a user to perform a selection of target data providers of said plurality of data providers and target fields from the ordered list of the data fields corresponding to the target data providers, and further enabling the user to indicate a selected operation to be performed on datasets to be generated by said selection;
retrieving data produced by the target data providers according to the target fields indicated by said selection so as to generate said datasets;
performing the selected operation on said datasets.

2. The method of claim 1, wherein said maintaining comprises providing a registration interface enabling registration of data providers.

3. The method of claim 2, wherein said registration of data providers comprises submitting data field names corresponding to data fields used in a data provider to be registered.

4. The method of claim 3, wherein said registration further comprises submitting record names corresponding to records stored in the data provider to be registered.

5. The method of claim 1, wherein said maintaining comprises storing a query network address and a results network address for each data provider of said plurality of data providers.

6. The method of claim 2, wherein said registration of data providers comprises submitting a query network address and a results network address for a data provider to be registered.

7. The method of claim 1, wherein said template comprises value fields corresponding to data fields of the respective data provider output.

8. The method of claim 7, wherein said value fields comprise record identification fields and record description fields.

9. The method of claim 7, wherein said value fields comprise variable names corresponding to variable data entries.

10. The method of claim 7, wherein said value fields are ordered according to the ordered list of the data fields of the respective data provider output.

11. The method of claim 1, wherein said retrieving comprises submitting queries to the target data providers and fetching said customized result page from each of said target data providers.

12. The method of claim 1, wherein said performing the selected operation comprises joining said datasets.

13. A computerized system enabling data mining from data providers accessible by a network, comprising:
a memory storing therein information of a plurality of data providers and an ordered list of data fields for each respective data provider;
a processor receiving first result data from a data provider of the selected data providers and storing said first result data as a first dataset organized according to the ordered list of data fields, said processor further receiving a second result data from a data provider of the selected data providers and storing said second result data as a second dataset organized according to the ordered list of data fields;
an interface enabling a user to indicate a selected operation to be performed on said first and second datasets; and,
a data mining module operable to perform the selected operation on said first and second datasets.

14. The system of claim 13, wherein said interface further enables the user to perform a selection of target data providers of said plurality of data providers and target fields from the ordered list of the data fields corresponding to the target data providers.

15. The system of claim 14, wherein said processor further functions to compose a query upon the user's selection of a target data provider and send the query to the target data provider.

16. The system of claim 13, further comprising a registration module functioning to receive field names from a registrant data provider and storing the field names in said memory.

17. The system of claim 16, wherein said registration module further functions to provide a template to said registrant data provider.

18. The system of claim 16, wherein said registration module further function to assign a category to said registrant data provider and to store said category in said memory.

19. The system of claim 18, wherein said registration module further function to assign a record name to records of said registrant data provider and to store said record name in said memory.

20. The system of claim 16, wherein said registration module further functions to modify said registrant data provider by adding a customized results page to said registrant data provider.

21. The system of claim 13, wherein said memory stores query page address and result page address for each of said plurality of data providers.

22. The system of claim 13, further comprising a query module for fetching a query page of a data provider and presenting a corresponding query page on said interface.

23. The system of claim 22, wherein aid query interface further inserts a modified result page address in said corresponding query interface.

24. A method for automatically generating a parser module for a query results page returned from a data provider, comprising:
displaying on a monitor the result page;
receiving a user input identifying fields of interest in said results page;
fetching from source code of said results page unique codes corresponding to each on of the fields;
generating a parser operable to receive a results page from said data provider and fetch data corresponding to said unique codes.
